(19) United States
(12) Patent Application Publication
(10) Pub. No.: US 2010/0002915 A1
(43) Pub. Date: Jan. 7, 2010

(54) FEEDBACK IN BIOMETRIC SYSTEMS

(75) Inventor: Michelle Govan, East Kilbride (GB)

Correspondence Address: FOLEY AND LARDNER LLP;SUITE 500, 3000 K STREET NW, WASHINGTON, DC, 20007, US

(73) Assignee: eCEBS Limited

(21) Appl. No.: 12/373,467

(22) PCT Filed: Jul. 13, 2007
(86) PCT No.: PCT/GB07/02646

§ 371 Date: May 6, 2009

(30) Foreign Application Priority Data
Jul. 14, 2006 (GB) 0614085.9
Jul. 14, 2006 (GB) 0614086.7

(51) Int. Cl. G06K 9/00

(52) U.S. Cl. 382/125; 382/115; 382/124

(57) ABSTRACT

In a method for matching candidate biometric data for example, fingerprint data, to a reference sample, data representing a first set of features derived from a candidate sample, for example macroscopic ridge details, is compared to a first set of values of the reference sample. Dependent on the outcome of this comparison, a determination may be made that there is no match or, alternatively, further data representing a second set of features derived from the candidate sample, for example, local minutiae characteristics, is selected from an available array of such data (which may be global minutiae characteristics) for comparison with a second, different set of values of the reference sample to determine whether there is a match. The first and second sets of values of the reference sample and the first and second sets of features of the candidate sample representing two different and independent features of the same biometric characteristic. This improves processing and computational demands to the extent that the method can be implemented on a smartcard without loss of accuracy to an unacceptable extent.

The present invention relates to a method for matching candidate biometric data to a reference sample in the context of security systems, and authentication and verification of identity.

The principle of feedback has been extensively researched from a control engineering and mathematical perspective, in order to influence the behaviour of dynamical systems. More importantly, feedback has been utilised as a method of attaining optimal performance by anticipating the effects of environmental disturbances and reducing system sensitivity to parameter variations and nonlinearities. Although primarily researched from an engineering perspective, due to its practical properties, feedback has been widely applied in non-engineering disciplines involving complex systems, including architecture, biology, computing, economics and finance. Nevertheless, its application within a biometric context has never been explored.

Similarly, the principle of feedforward has been widely applied within control engineering to influence the behaviour of dynamical systems. Again, however, its application within a biometric context as a method of eliminating disturbances and reducing computational load has never been explored.

As identity theft continues to grow at an unprecedented rate, it is increasingly accepted that traditional surrogate representations of identity (e.g., secret knowledge or possession of some physical token) can no longer provide the level of protection required in today's society. In response, both governments and commerce are placing an increased emphasis on the use of biometrics. Biometric methods are generally regarded as an unrivalled means of authentication, both in terms of verification and identification, and are considered a natural solution to alleviating the many problems which plague traditional authentication methods.

In contrast to traditional knowledge based methods (e.g., passwords, etc.), which remain static and establish authentication based on achieving an exact match between a reference alphanumeric string and entered candidate data, two biometric measurements from the same individual will seldom be identical. This is due to the intra-class variability (i.e., sources of distortion and anomalies) of biometric data. Biometric matching is based on probability rather than certainty, so that reliable matching is a challenging and computationally costly information processing problem, prone to errors in recognition performance, and requiring complex mathematical techniques. Whilst the computational costs of executing biometric techniques may be readily supported in real time on modern PC platforms, practical implementation of these techniques poses a much greater challenge when the target environment has limited computational resources. In general they have hitherto required more processing power and/or memory storage than can be provided on a smartcard device.

While biometric techniques are an extremely strong means of authentication, their widespread implementation has been hindered due to several inherent engineering constraints. Research studies have suggested that no single biometric modality (i.e., biometric characteristic, sensor type, algorithm, etc.) is capable of providing an optimum solution in terms of authentication accuracy, recognition performance (false acceptance rate(s) i.e., the frequency that a non authorised person is accepted as authorised and false rejection rate(s) i.e., the frequency that a authorised person is rejected), reliability and system characteristics (e.g., inter-class variations, intra-class variability and impostor rejection). In light of these practical limitations there has been an increased interest in the possibility of implementing enhanced solutions which combine, or have the capability to utilise, evidence from multiple biometric modalities. Such solutions would take advantage of the proficiency of each modality to strengthen reliability and security, as well as control vulnerabilities.

Multimodal biometrics solutions are not without their own potential drawbacks. It remains a significant challenge to provide enhanced performance while maintaining acceptable computational loads. Further, it is desirable not to reintroduce limitations in terms of system cost (e.g., sensor technology), or user acceptance and convenience (e.g., usability and longer verification times). One approach is to employ a hybrid architecture based on a single biometric indicator but contrasting and discriminating feature representations and matching algorithms. It is accepted that combining correlated modalities in this way cannot be expected to achieve the same practical benefits as the combination of uncorrelated modalities. However, the adoption of a hybrid approach can potentially alleviate inherent performance limitations.

Prior art algorithms outside the smartcard field have utilised an enhanced hybrid structure, based on a single biometric trait but using contrasting characteristics and/or matching algorithms to establish an authentication decision. This takes advantage of the proficiency of each individual modality to overcome limitations and, if designed correctly, to exhibit increased levels of performance. While the biometric trait employed in such structures is the same in both modalities, the feature definitions and the matching algorithms are essentially independent of one another. It is this independence combined with the modality combination strategies, which can potentially overcome limitations in performance levels.

By their very nature and structure (since they are based on the same biometric sample), the different threads of the hybrid architecture share generic detail between the different modalities, for example, in the case of fingerprint information, alignment detail between a reference template and the candidate sample.

While biometric methods have become established as the pinnacle of reliable authentication, biometric solutions are not infallible, and they raise important social issues, particularly the privacy and security of biometric data within central databases, where it may be vulnerable to interception, tampering and misuse. While it may be difficult to circumvent biometric systems, the consequences of an individual's biometric data being compromised are significantly greater, especially as biometric identifiers cannot be updated, altered or reissued. Sensitive data must be protected from disclosure to prevent identity fraud and preserve information privacy.

These concerns have led to a growing interest being shown in distributed (decentralised) architectures (i.e., storing biometric data on portable devices such as smartcards), enabling an individual to maintain control of his or her own details. While a distributed architecture is not suitable for identification applications (i.e., ‘whose biometric data is this?’), it can address many security issues associated with verification applications (i.e, ‘does this data belong to Adam?’). To distribute the template to an individual does not guarantee security or preserve privacy, the same potential vulnerabilities exist if the template has to be retrieved. It is therefore essential in any such system that the sensitive data is never permitted to leave the protected closed environment of the smartcard. Utilising the capabilities of a smartcard it is possible to implement an architecture which permits the critical matching decision to be performed within the same closed environment as the extracted biometric reference template is stored, enabling critical privacy and security problems to be overcome.

For such a system to be workable, that is, for it to be sufficiently secure to be practical, any smartcard-based scheme should allow the biometric reference template to remain in the secure closed environment of the smartcard. Consequently, the matching process must also be executed by the smartcard. Using a smartcard in this way also strengthens the authentication method, as it combines the biometric identifier with the traditional possession based methodology thus providing a dual factor authentication scheme.

Smartcards are highly functional devices capable of providing a secure and tamper-resistant means of storing and processing sensitive information (e.g., digital certificates, private keys and biometric templates), while maintaining portability in a card, which can be stored in an individual's pocket. The practical implementation of biometric authentication schemes employing smartcards is a challenge due to a number of significant technological constraints that characterise current generation, low power, smartcards:
limited computational power
restricted instruction set (e.g. provision of direct support for mathematical operations)
restricted code capacity
limited communication speed
limited memory

Technological constraints, for the present, have prohibited computationally-intensive applications (e.g., image processing, feature extraction, etc.) from being processed by the smartcard. Matching of biometric data on smartcards raises difficult engineering questions and remains a challenging prospect due to the magnitude and mathematical complexity of traditional algorithm design.

So, even with a smartcard's embedded microprocessor providing a secure and tamper-resistant means of storing and processing sensitive information, the smartcard's functionality is limited by technological constraints. To manage the demands of biometrics efficiently, any implementation within a restricted environment must be frugal in its consumption of memory and use processor cycles efficiently.

In accordance with a first aspect of the invention, there is provided a method for matching candidate biometric data to a reference sample, wherein data representing a first set of features derived from a candidate sample is compared to a first set of values of the reference sample, and, dependent on the outcome of that comparison, further data representing a second set of features derived from the candidate sample is selected from an available array of such data for comparison with a second, different set of values of the reference sample to determine whether there is a match; the first and second sets of values of the reference sample and the first and second sets of features of the candidate sample representing two different and independent features of the same biometric characteristic.

In a further aspect, the invention provides a method for matching candidate biometric data to a reference sample, wherein data representing a first set of features derived from a candidate sample is compared to a first set of values of the reference sample, and, dependent on the outcome of that comparison, either a determination that there is no match is made or further data representing a second set of features derived from the candidate sample is compared with a second, different set of values of the reference sample to determine whether there is a match; the first and second sets of values of the reference sample and the first and second sets of features of the candidate sample representing two different and independent features of the same biometric characteristic.

In preferred embodiments the biometric data to be matched and the reference sample are fingerprint data. Further, the first or second set of features of the candidate sample may represent macroscopic ridge characteristics, for example, ridge curvature, and are compared with values within the reference sample representing macroscopic ridge characteristics thereof. The first or second set of features of the candidate sample may represent local minutiae characteristics and may be compared with values within the reference sample representing local minutiae characteristics thereof.

Embodiments of the invention will now be described in detail, by way of example, with reference to the drawings, in which:

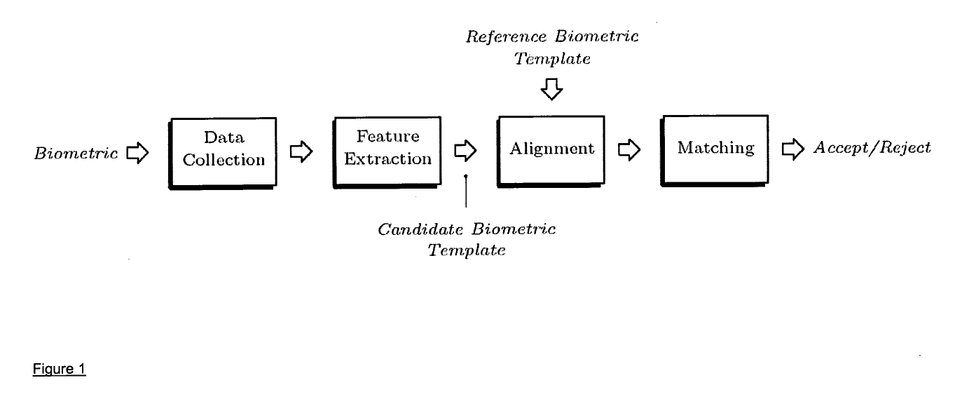

FIG. 1 is a block diagram illustrating a generic biometric system architecture;

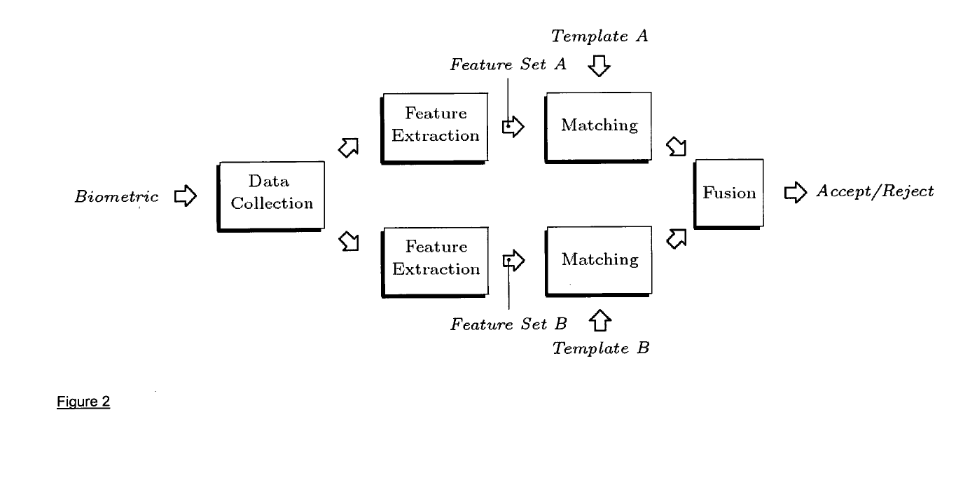

FIG. 2 is a block diagram illustrating a hybrid biometric system architecture;

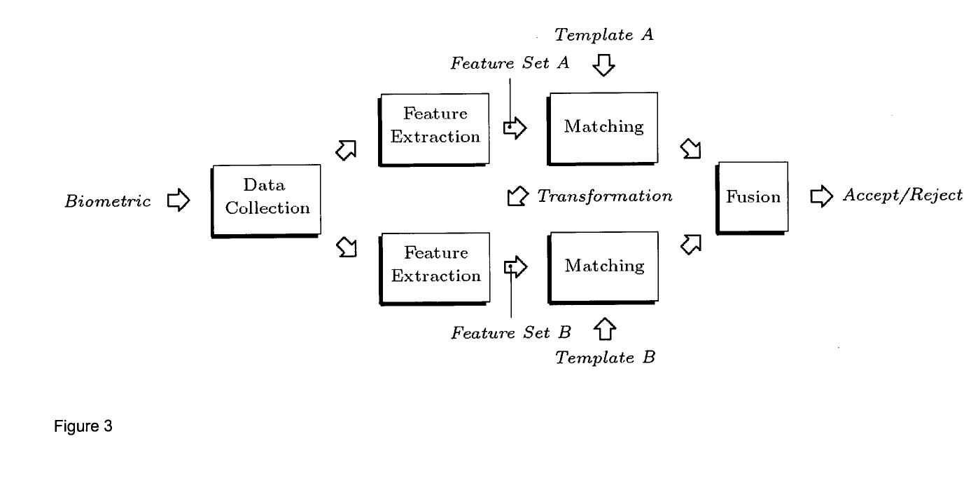

FIG. 3 is a block diagram illustrating a single input/single output multiple modality system with feedback;

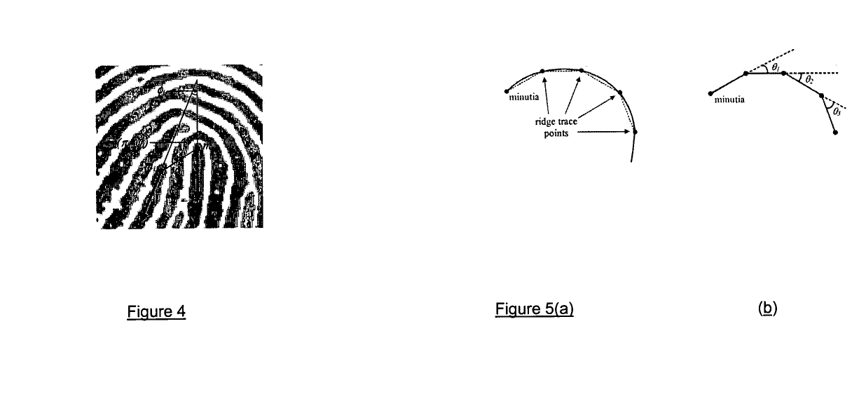

FIG. 4 is a graphical representation of local fingerprint features and relationships;

FIG. 5 shows (a) minutia ridge shape approximation and (b) representation; and

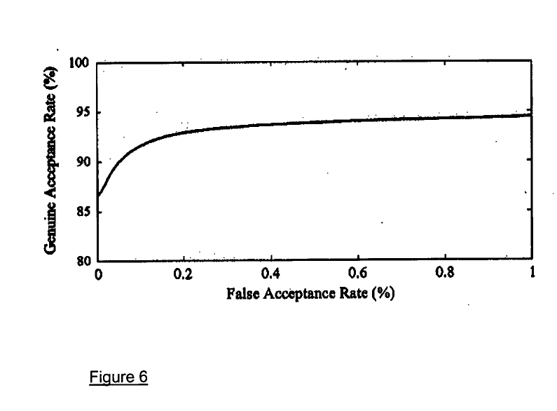

FIG. 6 illustrates verification performance of the method of the preferred embodiments.

As mentioned above, smartcards are highly functional devices which can provide a portable, yet secure and tamper-resistant means of storing and processing sensitive information. However, even allowing for advanced smartcard advanced architecture, including resident processing capability which enables the card to maintain highly secure encryption based security features, their functionality is restricted by technological constraints. For this reason, authentication processes utilising smartcard technology is preferably divided into the computationally intensive pre-processing and feature extraction phases (tasks which do not require the original biometric reference template) which are performed externally and the biometric matching algorithm, which is the only phase performed by the smartcard; a method referred to below as ‘match on card’.

Within a generic biometric system architecture, as illustrated in FIG. 1, each module (i.e., image capture, feature extraction, matching, etc.) exchanges data it has received or derived with subsequent modules. This process is generally assumed to be linear and exploits a causal framework. However, this may not necessarily have to be true; adaptations to the general model may sometimes be required. For example, this is the case with matching algorithms which are iterative in nature, i.e., various alignment configurations or matching operations are tried until an optimal result is determined. Similarly some matching algorithms require alignment between samples to be established before feature extraction can take place.

A hybrid biometric solution, as illustrated in FIG. 2, is based on a single biometric characteristic, for example, fingerprints, but utilises two or more different sources of unique information, for example, in the case of fingerprints, minutiae detail, ridge pattern structure, etc. to derive an authentication decision. This approach aims to combine the simplicity, user convenience and system cost of unimodal systems with the reliability and performance of multimodal techniques. While the biometric trait employed is the same in both modalities, the feature definitions and the matching algorithms used are essentially independent. This independence, combined with the modality combination strategies, can at least partially overcome limitations in performance levels. In experimental research studies it has been demonstrated that hybrid systems, based on the fusion of two distinctly independent matching techniques, can perform better than a unimodal matching scheme.

Hybrid solutions have the potential to improve performance accuracy and lessen the effects of the problems concerning the availability of useful discriminatory information. For instance, while minutiae techniques can give accurate results when used with good quality fingerprint images, they can be limited when presented with fingerprints with poor ridge definition. Conversely, algorithms which employ alternative ridge pattern techniques which work well with poorly defined fingerprint images often fail due to poor alignment between the candidate and reference images. Since the advantages and disadvantages of both methodologies tend to cancel each other out, it is possible to develop a hybrid solution which overcomes these limitations. Although the feature definitions and matching algorithms are independent, since they are based on a single trait they contain common characteristics and interconnected information, primarily, alignment information corresponding to the interaction between the reference template and the secondary acquired sample.

We have appreciated that where commonality exists between biometric inputs, that is, the system is based on a single biometric characteristic such as fingerprints, a feedback mechanism represents a simple design technique which gives a number of practical benefits while enabling some of the limitations associated with biometric matching algorithms to be overcome.

FIG. 3 illustrates the incorporation of a feedback mechanism within a generic single input/single output multi-modality system. The system of FIG. 3 allows the exchange and sharing of data between modalities and lessens the requirement to recalculate data which has already been established and is not subject to change, reducing the associated computational burden. For instance, the alignment between feature sets will be equivalent in both modalities if the feature sets are derived from the same primary biometric data. Therefore, given that alignment determination is a computationally complex and demanding stage in the matching of biometric data, eliminating this stage from the second comparison modality can make a significant reduction in the time taken for the secondary comparison to be completed.

As mentioned above, due to their outstanding characteristics (e.g., permanence and individuality) and historical background, the most widely employed physical characteristics in biometric authentication to date are fingerprints, the pattern of raised friction ridges and recessed valleys of skin on the surface of the fingertip. The science of fingerprint matching has been studied for centuries, and has resulted in a number of different classes of approaches being devised; primarily focusing on correlation-based, minutiae-based and ridge feature-based matching techniques. Whilst each approach has its merits and limitations, the most dominant approach, due to its strict analogy with the methods employed by forensic experts and its universal acceptance as proof of identity, is matching based on minutiae descriptions, that is ridge terminations or ridge bifurcations.

FIG. 4 is a graphical representation of local fingerprint features and their relationships. Each fingerprint minutia can be characterised by its x and y coordinates and ridge orientation φ. In addition, a set of spatial relationships can be derived between a reference minutiae mᵣ and it's nearest i^{th} minutiae. As illustrated in FIG. 4, δᵢ describes the Euclidean distance between the reference minutiae mᵣ and its i^{th} nearest minutiae; φᵢ represents the radial direction difference angle between the reference minutiae ridge oriental angle φᵣ and the i^{th} ridge orientation φᵢ; ψᵢ denotes the relative positional angle between the ridge orientation angle φᵣ and the direction of the segment connecting the i^{th} minutiae, where i=1, 2, . . . , N with N denoting the number of relationships taken into consideration. The spatial relationships can be determined:

$$\begin{matrix}{δ}_{i} = \sqrt{{( {x}_{i} - {x}_{r} )}^{2} + {( {y}_{i} - {y}_{r} )}^{2}} , & ( 1 a ) \\ {φ}_{i} = diff ( {ϕ}_{i} , {ϕ}_{r} ) , & ( 1 b ) \\ {ψ}_{i} = diff ( arctan ( \frac{{y}_{i} - {y}_{r}}{{x}_{i} - {x}_{r}} ) , {ϕ}_{r} ) , & ( 1 c )\end{matrix}$$

where the function diff calculates the difference between angles, defined in the range [0, 2π). The general model is defined by the feature vector

nⱼ=[{δ₁,φ₁,ψ₁}, {δ₂,φ₂,ψ₂}, . . . , {δ_{N},φ_{N},ψ_{N}}].

Minutiae structural relationships over small distances tend to be more reliable than over larger areas. Therefore, it is beneficial to extract structural models over small areas. In addition, structural distinctiveness, verification accuracy and system reliability is sensitive to the number of neighbour relationships, N, within a structural model, nⱼ. Since structural representations are based on a subset, they are less distinctive than the global minutiae set, thus, there is the probability that different fingers may exhibit similar structures.

From a computational perspective, in the context of smartcard implementation, the structural models, nⱼ, are invariant to global geometric transformations (rotation and translation) eliminating the requirement for global alignment. Alignment is a limitation of most algorithms, as it is computationally-intensive and thus typically performed off card, but this reintroduces security issues.

The matching algorithm compares each reference and candidate spatial relationship within the neighbourhood structural model, nⱼ, to evaluate whether structures are equivalent, and thus whether a positive verification decision is achievable. Allowable distortion thresholds (Δ_{δ}, Δ_{φ} and Δ_{ψ}) are introduced to account for inherent non-linear elastic distortions and perturbations (i.e., difference in the spatial relationships). If all three spatial conditions in equation (2) are satisfied, then the i^{th} reference relationship and the j^{th} candidate relationship are considered to match. Conversely, if any absolute difference exceeds the relative threshold then the relationships are rejected as not equivalent.

|δₖ_{ᵢ}−δ_{k′}_{ⱼ}|≦Δ_{δ}, (2a)

min(|φₖ_{ᵢ}−φ_{k′}_{ⱼ}|,2π−|φₖ_{ᵢ}−φ_{k′}_{ⱼ}|)≦Δ_{φ}, (2b)

min(|ψₖ_{ᵢ}−ψ_{k′}_{ⱼ}|,2π−|ψₖ_{ᵢ}−ψ_{k′}_{ⱼ}|)≦Δ_{ψ}. (2c)

The geometry of equivalent minutiae models may appear dissimilar due to interdependencies between minutiae (e.g., minutiae maybe dropped or erroneously detected). To reduce the effect of such anomalies, if the number of matched relationships is greater than a specific predetermined structural threshold, then the structures, nⱼ, are evaluated as equivalent.

Since there is the probability that dissimilar fingerprints will exhibit similar structural models, a positive verification cannot be established based on a single local structure match. However, the prospect of several structural models being defined as equivalent is extremely improbable. Based on this uniqueness, the algorithm will achieve a verification decision when the number of structural models found to be equivalent is equal or greater to a verification threshold.

The algorithm is designed to continue until all structural models have been evaluated, or until the predetermined number of structural models matches which define a positive verification decision has been achieved. Adopting this approach results in a difference in computational load, i.e., the matching procedure in cases where a match is achieved will almost certainly terminate before every structure has been compared; in contrast, in cases where the samples fail to establish a match a complete set of iterations will be undertaken. Thus, in respect to the execution time the algorithm exhibits asymmetric matching behaviour.

The selection of allowable distortion tolerances and match defining thresholds are algorithm design parameters which effects system recognition reliability and computational load, but are dependent on fingerprint sample resolution and quality, together with minutiae definition precision. The determinations of suitable parameter are best quantified through experimental analysis. From a security and privacy perspective, the solution is virtually attack free by design (data stored and executed on smartcard is protected by combined hardware and software mechanisms), but as the reference template never has to be released from the secure closed environment, it further enhances security. More importantly, since feature definitions are based only on local relationships it is difficult to reverse engineer data to reconstruct the global picture, even if candidate data was to be disclosed when communicating with the smartcard during the verification process.

From a computational perspective, the algorithm is tolerant to elastic non-linear ridge distortions and anomalies, yet does not involve computational complex calculations making it ideal for the intended smartcard environment. However, despite exhibiting asymmetric matching behaviour in respect to the execution time, interactive usage is limited by the magnitude of computations required. For example, if it is assumed that the templates consists of x and x′ structural models (potentially a template consists of between 20 to 70 minutiae with a structural model defined for each minutiae), there is the potential for xx′ structure comparisons to be evaluated. In addition, in each model their will be a further 3N² calculations required, where N represents the number of relationships (e.g., between to core minutiae and its surrounding minutiae) in the neighbourhood structure of which in each case a length and two angles are evaluated (to establish a distinctive structure definition, the number of relationships, N, will be in the magnitude of 8 to 15). Thus 3N²xx′ spatial comparisons are required to establish a verification decision.

As established above, the basic structure of the matching algorithm exhibits the fundamental characteristics which permit biometric authentication based on current generation smartcards. Nevertheless, for two representations of the same fingerprint it will be only possible to achieve at maximum x (where x<x′) structural matches. Thus, in the majority of comparisons undertaken there is no probability of a match being realised. This is further emphasised when two different fingers are assessed, a complete set of evaluations is undertaken, xx′, with little possibility of a structural model match being found. Therefore, from the xx′ comparisons undertaken the majority of comparisons assessed have very little probability of a match being achieved. While the computational complexity is within technological limits, the ability of the algorithm to be executed within a suitable interactive time-frame is severely limited by the number of irrelevant calculations. If the computational magnitude could be minimised by forming an assessment, based on a subset of details, whether further analysis would have beneficial results, real-time execution would be possible.

Adopting a similar design methodology to the architectures preferred within identification systems, (i.e., in order for real-time identification to be feasible within identification systems, it is important to reduce the computational search space and computational complexity by first categorising the data by global characteristics in order that only a subset of data for the original reference database, which have an increased probability of being a match, are compared), it is possible that data related to anomalies such as spurious minutiae can be removed by employing other characteristics associated with minutiae to establish whether the minutiae detected are real or a disturbance element. This process increases the reliability of the data, and reduces the computational resources required to establish whether a match can be achieved. By differentiating between equivalent and extraneous structural models (i.e., by eliminating data which is either insignificant and/or a distracter), execution time maybe minimised without adversely effecting recognition accuracy.

As described above, microscopic minutiae features are employed to establish a verification decision. By employing presently unutilised discriminative macroscopic ridge characteristics, which may be extracted more reliably than minutiae, it is possible to anticipate disturbances and redefine the search space, minimising computational magnitude and thus execution time, without introducing a decline in recognition accuracy. In this context, disturbance rejection is based on an assessment on the probability that neighbourhood structural models are equivalent, and from a computational perspective whether further analysis would be constructive from a matching perspective.

As depicted in FIG. 5(a), the macroscopic ridge curvature characteristics can be represented by a series of trace points extracted from the fingerprint ridge. Representing macroscopic detail in this form enables the curvature to be defined in terms of the difference between the angles of the linear segments, as illustrated in FIG. 5(b). Whilst it is not the most descriptive representation, adopting this approach ensures that the representations are independent of geometric transformations (rotation and translation), but also enables simple analysis, therefore not adversely effecting the computational load. Utilising k trace points ridge curvature is defined:

rᵢ={θ₁,θ₂, . . . , θₖ₋₁},

the modified model, including ridge curvature, is defined:

ñⱼ=[{θ₁,θ₂, . . . ,θₖ₋₁}, {δ₁,φ₁,ψ₁}, {δ₂,φ₂,ψ₂}, . . . , {δ_{N},φ_{N},ψ_{N}}].

The selection of trace points, k, is selected to obtain a compromise between ridge distinctiveness, template size and tolerance to deformation. To maintain computational simplicity, to establish whether the ridge structures are likely to be equivalent a difference method can be adopted: ridge structures are assumed equivalent between different models if all the absolute differences in ridge angles are below the associated threshold:

min(|θₖ_{ᵢ}−θ_{k′}_{ⱼ}|,2π−|θₖ_{ᵢ}−θ_{k′}_{ⱼ}|)≦Δ_{θ}_{ₖ}.

A series of ridge curvature thresholds are employed in order to address non-elastic distortions in the ridge structure. For ridge structures which exhibit similar characteristics the original local minutiae structure assessment is undertaken, but if the ridge structures are dissimilar further analysis is deemed unnecessary. While ridge structure definitions are not sufficiently distinctive to establish a verification decision, for structural models which are dissimilar it is possible to establish this in three basic comparisons rather than the full 3N² analysis. The optimised methodology enables the execution time to be vastly reduced, potentially by a factor of N², without adversely effecting reliability.

Inspection of the ridge structure characteristics identifies that they are distinctive in terms of curvature radius, the direction of flow (clockwise or counter clockwise) and ridge anomalies. Initial experimental validation of a subset of data demonstrates that, taking into consideration deformation tolerances incorporated, the probability of similar ridge structures within the same fingerprint structure is small. Conversely, in relationship to dissimilar fingerprints there is a marginally higher prospect that similar ridge structure characteristics will be identified. Despite ridge structure definitions not being as unique as minutiae details, they are sufficiently distinctive to provide characteristics on which to define disturbance rejection.

In order to validate the potential benefits presented by the inclusion of the disturbance rejection methodology, ridge tolerances are selected to ensure that no equivalent ridge definitions are denied (i.e., recognition performance will not be adversely effected). In addition, each template will contain the same number of structural models, \tilde{x} (i.e. \tilde{x}=x=x′). Experimental results have illustrated the difference in the magnitude of calculations undertaken to achieve the same verification decision. This equates to a potentially significant reduction in the computational magnitude, in the cases where samples obtain a positive verification decision (where an element of refinement is already realised), but more significantly so when a match could not be established.

From a practical implementation perspective, the potential reduction in computational magnitude can equate to a verification decision being established in less than two seconds within the resource constrained smartcard environment, which is believed a suitable time frame for practical and interactive usage, compared to an execution time in excess of thirty seconds when a match was not achieved (i.e. a complete set of iterations undertaken) with the algorithm without disturbance rejection applied.

Eliminating a fraction of the comparison assessments has a substantial impact on execution time without introducing any deterioration in recognition accuracy. In addition it my be beneficial to increase the level of disturbance rejection to further refine the magnitude of computation. Although this may adversely effect recognition accuracy, it may in some circumstances be acceptable.

Under closer inspection, this concept has many parallels with the design philosophy of feedforward, a technique which has played a vital role in advances in science and engineering. Anticipating the influence of measurable environmental disturbances it is feasible to reduce system sensitivity to parameter variations and nonlinearities by manipulating their effects on essential variables in order to maintain some desired system state.

Although the system described above has been presented in the context of fingerprints and smartcards, due to the generic biometric architecture adopted, it is possible to extend the design concept to other biometric identifiers with similar practical effects, dependent on the independence between feature definitions, providing there is sufficient commonality between modalities. In addition, it is not limited to those implemented within the smartcard framework.

Furthermore, if the secondary features employed to anticipate disturbances contain sufficient distinctive characteristics, it is possible that a verification decision may be derived on these features alone. Consequently, the overall system performance could be strengthened by the fusion of two independent verification decisions at the same time as reducing computational requirements.

To assess verification performance, the evaluation procedures outlined in Maio, D., Maltoni, D., Cappelli, R., Wayman, J. L., Jain, A. K.: FVC2000: Fingerprint Verification Competition. IEEE Trans. on Pattern Analysis&Machine Intelligence 24 (2002), 402-412. were adopted and conducted on the associated public domain collection of images. The selection of algorithm design parameters, allowable distortion tolerances and the match defining thresholds, which are best quantified through experimental analysis, are able to be manipulated enabling the security indicators of FAR₁₀₀ (the highest achievable genuine acceptance rates (GAR) for a false acceptance rate (FAR)<1%), FAR₁₀₀₀ (the highest GAR for FAR<0.1%) and _{zero}FAR (the highest GAR for at which no false matches occur (FAR=0%)) to be assessed.

Examining the verification performance reveals genuine acceptance rates of 94.5%, 91.6% and 86.6% for FAR₁₀₀, FAR₁₀₀₀ and _{zero}FAR, respectively. The results are depicted in FIG. 6. A further improvement in recognition accuracy can be observed when the minutiae characteristics are defined with higher precision enabling the derived structural model to be expressed with superior accuracy. It is observed that the system is capable of achieving acceptable performance levels for its application context, while maintaining a suitable level of complexity.

1. A method for matching candidate biometric data to a reference sample, wherein data representing a first set of features derived from a candidate sample is compared to a first set of values of the reference sample, and, dependent on the outcome of that comparison, further data representing a second set of features derived from the candidate sample is selected from an available array of such data for comparison with a second, different set of values of the reference sample to determine whether there is a match; the first and second sets of values of the reference sample and the first and second sets of features of the candidate sample representing two different and independent features of the same biometric characteristic

2. A method for matching candidate biometric data to a reference sample, wherein data representing a first set of features derived from a candidate sample is compared to a first set of values of the reference sample, and, dependent on the outcome of that comparison, either a determination that there is no match is made or further data representing a second set of features derived from the candidate sample is compared with a second, different set of values of the reference sample to determine whether there is a match; the first and second sets of values of the reference sample and the first and second sets of features of the candidate sample representing two different and independent features of the same biometric characteristic.

3. A method according to claim 1 wherein comparison of the data representing the first set of features with the first set of values of the reference sample requires alignment of that data with the said first set of values, the method comprising deriving alignment information to enable that comparison to be made and using the alignment information so derived in the any comparison of the data representing the second set of features with the second set of values of the reference sample.

4. A method according to claim 1 wherein the biometric data to be matched and the reference sample are fingerprint data.

5. A method according to claim 4 wherein either the first or second set of features of the candidate sample represent macroscopic ridge characteristics and are compared with values within the reference sample representing macroscopic ridge characteristics thereof.

6. A method according to claim 5 wherein the macroscopic ridge characteristic is ridge curvature.

7. A method according to claim 1 wherein the either the first or second set of features of the candidate sample represent local minutiae characteristics and are compared with values within the reference sample representing local minutiae characteristics thereof.

8. A smartcard comprising memory for storing data representing either the candidate sample or the reference sample and a processor operable to carry out the method of claim 1.
